(19) United States
(12) Patent Application Publication
(10) Pub. No.: US 2024/0423760 A1
(43) Pub. Date: Dec. 26, 2024

(54) DENTAL APPLIANCE SYSTEM AND AN ORTHODONTIC METHOD USING THE SAME

(71) Applicant: WUXI EA MEDICAL INSTRUMENTS TECHNOLOGIES LIMITED, Wuxi (CN)

(72) Inventors: Xiao DENG, Wuxi (CN); Jie TIAN, Wuxi (CN); Huimin PENG, Wuxi (CN); Fang SONG, Wuxi (CN); Yikan ZHENG, Wuxi (CN)

(21) Appl. No.: 18/749,572

(22) Filed: Jun. 20, 2024

Related U.S. Application Data
(60) Provisional application No. 63/509,276, filed on Jun. 20, 2023.

(51) Int. Cl. A61C 7/10; A61C 7/36

(52) U.S. Cl. CPC A61C 7/10; A61C 7/36

(57) ABSTRACT

A dental appliance system comprises: a set of dental appliances for progressively closing a tooth gap between a group of posterior teeth and an intermediate tooth in a patient's dentition, wherein the intermediate tooth is adjacent to the tooth gap and between the tooth gap and a group of anterior teeth in the patient's dentition; and wherein the set of dental appliances comprises: a first plurality of dental appliances for implementing anchorage preparation for the group of posterior teeth and performing one or both of moving the intermediate tooth distally and treating the group of anterior teeth; and a second plurality of dental appliances for mesially moving the group of posterior teeth after the anchorage preparation for the group of posterior teeth has been implemented by the first plurality of dental appliances.

### TECHNICAL FIELD

The present application generally relates to orthodontic techniques, and more particularly, to a dental appliance system and an orthodontic method using such dental appliances.

### BACKGROUND OF THE INVENTION

For many patients with irregular dentitions, in order to better implement orthodontic treatment, a part of teeth in the patient's mouth may need to be removed to provide enough space for rearranging the remaining teeth. The removal of premolars is a common treatment option. After removing premolars or other teeth, teeth on both sides of gap(s) formed due to the tooth removal or extraction need to be moved towards each other to close the gap(s). However, existing clear orthodontic solutions involving removal of premolars often require a longer orthodontic treatment period due to reasons such as anchorage preparation for posterior teeth.

Therefore, it is desired to provide an improved dental appliance system and an orthodontic method using such dental appliance system.

### SUMMARY OF THE INVENTION

An objective of the present application is to provide a dental appliance system and an orthodontic method to reduce an orthodontic treatment period to implement the orthodontic method.

According to an aspect of the present application, a dental appliance system is provided. The dental appliance system comprises a set of dental appliances configured for rearranging teeth after removal of a tooth in a patient's dentition, and at least one or more of the dental appliances are capable of moving a cuspid tooth of the patient's dentition distally while implementing anchorage preparation for a group of posterior teeth.

In some preferred embodiments, at least one or more of the dental appliances are capable of moving a cuspid tooth or teeth of the patient's dentition distally and retracting an anterior tooth or teeth (i.e., an incisor teeth) of the patient's dentition while implementing anchorage preparation for a group of posterior teeth.

In some preferred embodiments, the set of the dental appliances further comprise one or more dental appliances that are capable of retracting an anterior tooth or teeth in the patient's dentition while moving the group of posterior teeth mesially after the anchorage preparation for the group of posterior teeth.

According to another aspect of the present application, an orthodontic method using a dental appliance system is provided. The orthodontic method is implemented by the dental appliance system in the above aspect of the present application.

It is to be understood that both the foregoing general description and the following detailed description are exemplary and explanatory only, and are not restrictive of the invention. Further, the accompanying drawings, which are incorporated in and constitute a part of this specification, illustrate embodiments of the invention and together with the description, serve to explain the principles of the invention.

### BRIEF DESCRIPTION OF DRAWINGS

The drawings referenced herein form a part of the specification. Features shown in the drawing illustrate only some embodiments of the application, and not of all embodiments of the application, unless the detailed description explicitly indicates otherwise, and readers of the specification should not make implications to the contrary.

FIG. 1 illustrates an orthodontic method using a dental appliance system according to an embodiment of the present application.

FIG. 2 illustrates an example of preparing anchorage for a tooth No. 7.

FIG. 3 illustrates an example of moving a cuspid tooth a distally.

FIG. 4 illustrates an example of moving posterior teeth mesially and retracting anterior teeth.

FIG. 5 illustrates an example of retracting an anterior tooth.

FIG. 6 illustrates an example of moving a posterior tooth mesially.

The same reference numbers will be used throughout the drawings to refer to the same or like parts.

### DETAILED DESCRIPTION OF THE INVENTION

The following detailed description of exemplary embodiments of the application refers to the accompanying drawings that form a part of the description. The drawings illustrate specific exemplary embodiments in which the application may be practiced. The detailed description, including the drawings, describes these embodiments in sufficient detail to enable those skilled in the art to practice the application. Those skilled in the art may further utilize other embodiments of the application, and make logical, mechanical, and other changes without departing from the spirit or scope of the application. Readers of the following detailed description should, therefore, not interpret the description in a limiting sense, and only the appended claims define the scope of the embodiment of the application.

In this application, the use of the singular includes the plural unless specifically stated otherwise. In this application, the use of “or” means “and/or” unless stated otherwise. Furthermore, the use of the term “including” as well as other forms such as “includes” and “included” is not limiting. In addition, terms such as “element” or “component” encompass both elements and components including one unit, and elements and components that include more than one subunit, unless specifically stated otherwise. Additionally, the section headings used herein are for organizational purposes only, and are not to be construed as limiting the subject matter described.

As used herein, spatially relative terms, such as “beneath”, “below”, “above”, “over”, “on”, “upper”, “lower”, “left”, “right”, “vertical”, “horizontal”, “side” and the like, may be used herein for ease of description to describe one element or feature's relationship to another element(s) or feature(s) as illustrated in the Figures. The spatially relative terms are intended to encompass different orientations of the device in use or operation in addition to the orientation depicted in the Figures. The device may be otherwise oriented (rotated 90 degrees or at other orientations) and the spatially relative descriptors used herein may likewise be interpreted accordingly. It should be understood that when an element is referred to as being “connected to” or “coupled to” another element, it may be directly connected to or coupled to the other element, or intervening elements may be present.

As used herein a “torque” encompasses a force applied on an object such as a tooth at a distance from a center of resistance. The torque may be calculated with a vector cross product of a vector force applied to a location corresponding to a displacement vector from the center of resistance. The torque may comprise a vector pointing in a direction. A torque opposing another torque may encompass one of the torque vectors oriented toward a first side of the object and the other torque oriented toward an opposite side of the object. A tooth comprising a torque or applied with a torque refers to a tooth with a force acting on the tooth about a center of resistance. The force can be generated by a dental appliance coupled to the tooth, either directly or with an attachment or similar features on the tooth, and combinations thereof.

The center of resistance of an individual tooth can be located near the bifurcation or trifurcation of the root of the tooth, for example. For a single rooted tooth, the center of resistance can be located somewhere between about 25% and about 70% of the distance from the alveolar crest to the apex of the root, for example about 40% of the distance.

In many embodiments, one or more posterior teeth comprise one or more of a molar, a premolar, or a canine, and one or more anterior teeth comprise one or more of a central incisor, a lateral incisor, a cuspid, a first bicuspid or a second bicuspid. For example, “posterior teeth” may be used herein to refer to the molars and premolars and “anterior teeth” may be used herein to refer to the incisors and canines. It shall be appreciated that “posterior” and “anterior” may also refer to the relative positioning of groups of one or more teeth, e.g., “posterior teeth” may refer to any teeth that are disposed posteriorly relative to one or more “anterior teeth,” and “anterior teeth” may refer to any teeth that are disposed anteriorly relative to one or more “posterior teeth”.

The embodiments disclosed herein can be used to couple groups of one or more teeth to each other. The groups of one or more teeth may comprise a first group of one or more anterior teeth and a second group of one or more posterior teeth. The first group of teeth can be coupled to the second group of teeth with removable dental appliances, i.e., polymeric shell appliances as disclosed herein.

The present application provides dental appliances and related orthodontic methods for designing and providing improved or more effective tooth moving systems for eliciting a desired tooth movement and/or repositioning teeth into a desired arrangement.

For existing dental appliance-based treatment plans involving premolars extractions, due to reasons such as anchorage preparation for posterior teeth (the teeth that provide anchorage are those that bear reaction forces applied by teeth to be moved), it is often desired to move a cuspid tooth distally after implementing anchorage preparation for the posterior teeth. Such treatment plan that implements the anchorage preparation for the posterior teeth and the distal movement of the cuspid tooth at different stages may require a longer orthodontic treatment period. The inventors of the present application proposed a new dental appliance based orthodontic method that allows advancing the distal movement of the cuspid tooth to begin at the same time as the anchorage preparation for the posterior teeth, or at least no later than an end of the anchorage preparation for the posterior teeth. In other words, the distal movement of the cuspid tooth can be implemented at least partially together with the anchorage preparation for the posterior teeth. For example, the distal movement of the cuspid tooth and the anchorage preparation for the posterior teeth may be implemented simultaneously in at least one orthodontic stage. This new orthodontic treatment plan may effectively reduce the number of stages of an orthodontic treatment, thereby reducing the required orthodontic treatment period and costs of the orthodontic process. Preferably, the orthodontic process (e.g., alignment) of the anterior teeth (i.e., incisor teeth) may be advanced to begin at the same time as or slightly later than the distal movement of the cuspid tooth, but the alignment of the anterior teeth and the distal movement of the cuspid tooth may be implemented at the same time as one or more stages of the anchorage preparation for the posterior teeth. This orthodontic process may further reduce the required orthodontic treatment period of the patient.

In some embodiments, each dental appliance of the dental appliance system comprises a polymeric shell, the polymeric shell comprising a plurality of activation sites to store energy with a plurality of deflections of the polymeric shell in order to direct movement of the teeth. One or more of the plurality of deflections can store energy with a force against the tooth, the force can be insufficient to move the tooth in a direction opposite the deflection when the tooth comprises a target position and orientation, and additional deflection can generate sufficient increased force to move the tooth in response to the tooth moving away from the target position and orientation. The target position and orientation can comprise a non-extruded position and orientation of the tooth and the force can be oriented in an intrusive direction and insufficient to intrude the tooth and sufficient to inhibit extrusion of the tooth. The target position and orientation can comprise a non-intruded position and orientation of the tooth corresponding to a stage of the appliance and the force can be oriented in an extrusive direction and insufficient to extrude the tooth and sufficient to inhibit intrusion of the tooth.

In some embodiments, a user adjusts positions and orientations of the teeth shown on a display with user input for a stage of treatment corresponding to the dental appliance, wherein each of the plurality of tooth receiving cavities comprises a cavity shape profile corresponding to a tooth shape profile of a tooth to be received in the cavity, and wherein each cavity shape profile is positioned and/or oriented away from a corresponding tooth shape profile position and orientation shown on the display in order to provide activation energy to the appliance when placed on the plurality of teeth.

In another aspect, a system to generate a plurality of dental appliances for moving a plurality of teeth of a patient is provided. The system comprises: an input; a display; and a processor coupled to the display and the input. The processor can comprise instructions embodied on a tangible medium to: display the plurality of teeth of the subject at a plurality of stages of a treatment, each stage corresponding to one of the plurality of dental appliances, adjust each of the plurality of teeth on the display to a position and an orientation in response to user input to position the teeth at each of a plurality of stages of the treatment, and determine a shape profile of a dental appliance shaped for placement on the plurality of teeth at a corresponding stage of treatment.

In a further aspect, a method for producing a plurality of digital data sets representing a series of discrete tooth arrangements progressing from an initial arrangement to a final arrangement is provided. The method comprising: providing a digital data set representing an initial tooth arrangement; providing a digital data set representing a final tooth arrangement; producing a plurality of successive digital data sets based on the provided digital data sets, wherein said plurality of digital data sets represent a series of successive tooth arrangements progressing from the initial tooth arrangement to the final tooth arrangement and each corresponding a stage of a series of orthodontic stages for progressively closing a tooth gap between a group of posterior teeth and an intermediate tooth in a patient's dentition; wherein the series of orthodontic stages comprises: a first plurality of orthodontic stages for implementing anchorage preparation for the group of posterior teeth and performing one or both of moving the intermediate tooth distally and treating the group of anterior teeth; and a second plurality of orthodontic stages for mesially moving the group of posterior teeth after the anchorage preparation for the group of posterior teeth has been implemented by the first plurality of orthodontic stages.

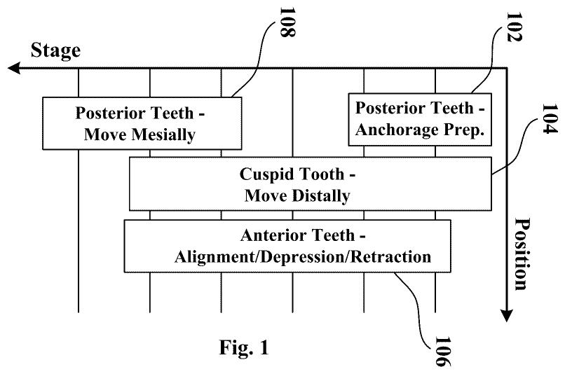

FIG. 1 illustrates an orthodontic method using a dental appliance system according to an embodiment of the present application. In some embodiments, the orthodontic method may be implemented by a set of dental appliances, and each of the set of the dental appliances is used to implement one orthodontic stage or step of the method. In this embodiment, two first premolars (teeth No. 4) in a dentition of a patient have been removed, and then the remaining teeth are continued to be moved and aligned. It can be appreciated that in some other embodiments, second premolars or other teeth in the patient's mouth that are located in the middle of each side of the dentition or near other desired locations (e.g., the first molar or the second molar) may be removed, and the orthodontic method using the dental appliance system of the present application may be implemented similarly.

As shown in FIG. 1, the orthodontic method using a dental appliance system is represented in the form of a coordinate system. A horizontal axis of the coordinate system shows respective positions of teeth, which illustrates, from left to right, a group of posterior teeth (i.e., the second premolar (tooth No. 5), the first molar (tooth No. 6), the second molar (tooth No. 7), and in some cases, the third molar), the cuspid tooth or teeth (tooth No. 3), a group of anterior teeth (or known as a group of incisor teeth, i.e., the mesial incisor (tooth No. 1) and the lateral incisor (tooth No. 2)). A vertical axis of the coordinate system shows different time stages of the orthodontic method, with an upper part indicating a beginning stage and a lower part indicating orthodontic stages that are subsequently implemented. It can be appreciated that the group of posterior teeth are the teeth closer to a distal direction with respect to the removed teeth, the cuspid tooth is the teeth adjacent to the removed teeth but closer to the mesial direction, and the group of anterior teeth are the teeth closer to the mesial direction with respect to the cuspid tooth. It can be appreciated that in most cases, the first premolar (tooth No. 4) may be removed to form a tooth gap in the patient's dentition which is to be closed after the orthodontic process for the patient, and accordingly the teeth posterior to the removed first premolar may be regarded as the group of posterior teeth, the cuspid tooth or teeth adjacent to the first premolar may be regarded as an intermediate tooth, and the mesial incisor and lateral incisor may be regarded as the group of anterior teeth because they are anterior to the intermediate tooth, i.e., the first premolar. However, in some other cases, the second premolar (tooth No. 5) may be removed. In that case, the teeth posterior to the removed second premolar, i.e., the first molar and the second molar and, if any, other more posterior tooth, may be regarded as the group of posterior teeth, the first premolar tooth adjacent to the second premolar, and optionally the cuspid tooth adjacent to the first premolar, may be regarded as an intermediate tooth, and the mesial incisor and lateral incisor may be regarded as the group of anterior teeth because they are anterior to the intermediate tooth. In the following, the invention is described with reference to the case that the first premolar (tooth No. 4) is be removed to form a tooth gap, but it can be appreciated that similar operations or processing may be performed for the case that the second premolar (tooth No. 5) is be removed to form a tooth gap. Furthermore, although the tooth gap to be closed can generally be formed after removal of a tooth, but in some cases, the tooth gap may be natural and may not necessarily be associated with or caused from the removal of a tooth. However, such tooth gap may be significant, such as greater than 2 mm, or preferably greater than 4 mm, or more preferably greater than 8 mm.

In this embodiment, the orthodontic method begins with step 102 of anchorage preparation for the posterior teeth, at which stage anchorage for each tooth in the group of posterior teeth may be prepared. For example, anchorage preparation can be implemented by inclining a crown of a tooth distally or inclining a root of a tooth mesially. At the same time or at a substantially similar time (e.g., earlier or later), the cuspid tooth is moved distally in step 104. It can be appreciated that the distal movement of the cuspid tooth may require the teeth in the group of posterior teeth to provide an anchorage force, and the distal movement of the cuspid tooth at this position may generate an anchorage force in the mesial direction to the teeth in the group of posterior teeth. The mesial anchorage force may produce a mesial inclination torque to the posterior teeth, which is inconsistent with the desired distal inclination torque to the posterior teeth during the anchorage preparation for the posterior teeth. If the torque that results in the distal inclination of the posterior teeth cannot be eliminated, then it is desired to introduce additional anchorage for the posterior teeth in order to achieve better effect of anchorage preparation for the posterior teeth.

In one example, in order to increase the anchorage for the posterior teeth, during the anchorage preparation of each tooth in the group of posterior teeth, the posterior tooth can be prepared for anchorage, and the remaining two (or three) posterior teeth can provide anchorage for the posterior tooth for which anchorage is being prepared. For example, when tooth No. 7 is prepared for anchorage, tooth No. 5 and tooth No. 6 can provide anchorage for tooth No. 7. When tooth No. 6 is prepared for anchorage, tooth No. 5 and tooth No. 7 can provide anchorage for tooth No. 6. When tooth No. 5 is prepared for anchorage, tooth No. 6 and tooth No. 7 can provide anchorage for tooth No. 5. Preferably, teeth closer to the distal direction may have priority to be prepared for anchorage, that is, anchorage may be prepared for the teeth in the order of No. 7, No. 6 and No. 5. However, in some practical applications, teeth in the group of posterior teeth may also be prepared for anchorage in other order. It can be appreciated that since the teeth in the group of posterior teeth are adjacent to each other, they can provide relatively grater anchorage force for each other. In some practical applications, other teeth that have not been moved or teeth that are moved in a direction opposite to that of the tooth for which anchorage is being prepared may serve as anchorage teeth. In some embodiments, the anchorage provided by the teeth mainly depends on forces generated due to the deformation of the dental appliances themselves. However, in some alternative embodiments, the anchorage provided by the teeth may also depend on additional attachments or other means that can generate or apply forces.

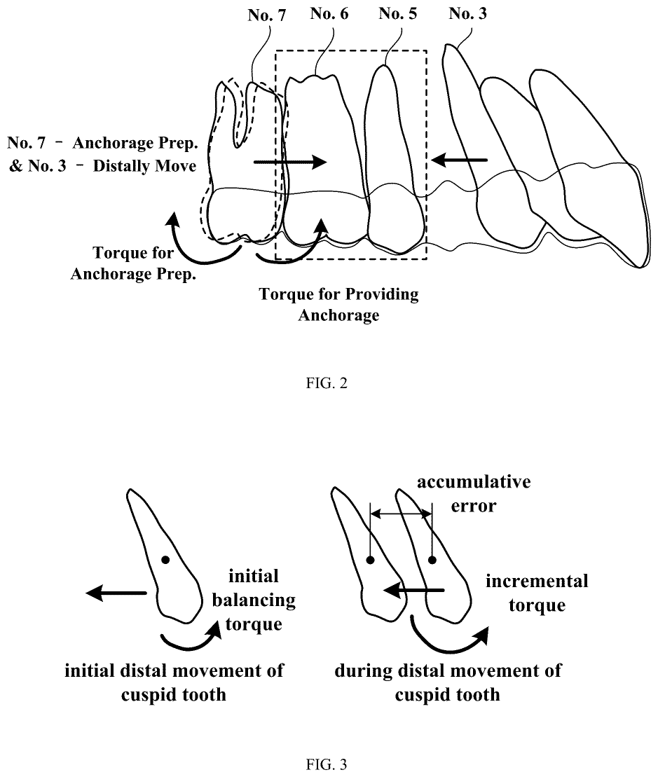

FIG. 2 illustrates an example of anchorage preparation of tooth No. 7. As shown in FIG. 2, tooth No. 5 and tooth No. 6 of the group of three posterior teeth provide an anchorage preparation torque to tooth No. 7. Compared with traditional anchorage preparation for the posterior teeth where only one tooth is used for anchorage preparation to adjacent teeth, in the present application, using multiple teeth to prepare anchorage for a single posterior tooth may provide additional anchorage force, which may reduce or eliminate the anchorage force on the posterior teeth due to the distal movement of the cuspid tooth.

In one embodiment, anchorage preparation for the posterior teeth may be implemented by inclining the posterior distally, as shown by the anchorage preparation torque in FIG. 2. There are two main considerations to apply this approach. Firstly, the posterior teeth that are inclined distally may bear a larger anchorage force. Secondly, the posterior teeth may be moved mesially throughout the orthodontic process, and therefore a pre-set angle in the distal direction may provide a margin when the posterior teeth are pushed mesially (which may cause the posterior teeth to incline mesially) during the subsequent stages of the orthodontic process.

As mentioned above, when the posterior teeth are being prepared for anchorage, step 104 is implemented simultaneously. That is, the cuspid tooth is moved distally. FIG. 3 shows an example of moving the cuspid tooth in the dentition distally. As shown in FIG. 3, when the cuspid tooth begins to move distally, an initial balancing torque may be applied to the cuspid tooth. The initial balancing torque may counter the torque that causes the cuspid tooth to move distally, that is, may cause the cuspid tooth to rotate mesially. In some preferred embodiments, for a set of dental appliances implementing an orthodontic method, the number of dental appliances that are capable of simultaneously implementing anchorage preparation for the posterior teeth and the distal movement of the cuspid tooth is at least 30%, preferably at least 50%, more preferably at least 75%, and the most preferably at least 90% of the number of dental appliances that are capable of implementing anchorage preparation for the posterior teeth. In some other embodiments, the number of dental appliances that are capable of simultaneously implementing the anchorage preparation for the posterior teeth and the distal movement of the cuspid tooth may be at least 5, and preferably at least 10. It can be appreciated that the maximum number of dental appliances that are capable of simultaneously implementing the anchorage preparation for the posterior teeth and the distal movement of the cuspid tooth is generally related to the number of dental appliances used for the anchorage preparation for the posterior teeth.

The balancing torque is applied because a sum of the balancing torque and the force that causes the tooth to move distally may allow the cuspid tooth to translate during its distal movement. This balancing torque does not need to be reflected in the actual movement (i.e., the tooth does not actually rotate in this direction). In other words, the applied balancing torque is actually the torque that is required by the tooth translation. In order to better balance the force that causes the tooth to move distally, an initial balancing torque with a certain magnitude may be applied at the beginning of the distal movement of the cuspid tooth to achieve the required “balance” state. The method using the initial balancing torque is different from a traditional orthodontic overcorrection method. In the traditional orthodontic overcorrection method, a rotation angle for the overcorrection is evenly distributed in all the steps of the distal movement of the cuspid tooth. That is, for example, for an overcorrection of 10 degrees, on condition that the overcorrection is evenly distributed in 30 steps of the distal movement of the tooth, only about 0.3 degree of overcorrection can be implemented in each step. The traditional orthodontic overcorrection method cannot provide a balancing torque which is required by the tooth translation, especially in the initial stage of distal movement of the cuspid tooth. In addition, the balancing torque of the cuspid tooth may cause a crown of the cuspid tooth to incline mesially, which is also beneficial for the crown of the posterior teeth to incline distally. This is because the two inclining directions may form interactive anchorage to each other, which is beneficial for the anchorage preparation (i.e., the balancing torque of the cuspid tooth that causes the crown of the cuspid tooth to incline (move) mesially, and a reaction force due to the torque at the posterior teeth may be beneficial for the crown of the posterior teeth to incline distally).

In some embodiments, the initial balancing torque applied to the cuspid tooth may primarily depend on a size of a tooth gap to be closed, for example, after the removal of the first premolar (tooth No. 4). The initial balancing torque may be, for example, from 0.1 degree to 20 degrees, or from 0.3 degree to 10 degrees, or from 1 degree to 5 degrees, or preferably from 1 degree to 3 degrees. In short, the initial balancing torque is significantly greater than the balancing torque that is achieved by way of even distribution. It can be appreciated that after applying a large initial balancing torque at the initial stage of the distal movement of the cuspid tooth, the balancing torque may gradually increase at subsequent stages of the orthodontic treatment until it increases to a desired mesial inclination angle (i.e., a desired balancing torque), and the balancing torques at the subsequent stages of the orthodontic process as described herein are defined relative to the initial state of the tooth. In some examples, the initial balancing torque applied to the cuspid tooth is no more than 6 degrees. For example, in the case that the initial balancing torque is 3 degrees and the desired final balancing torque is 15 degrees, and the entire orthodontic process may require 31 orthodontic stages of distal movement of the cuspid tooth, the corresponding balancing torque for each of these 31 orthodontic stages may increase by 0.4 degree. For example, the initial balancing torque of the first orthodontic stage is 3.4 degrees, the balancing torque of the second orthodontic stage is 3.8 degrees, and the balancing torque of the third orthodontic stage is 4.2 degrees. The similar process may continue until the balancing torque of the 21st orthodontic stage is 15 degrees. In other words, the balancing torque may gradually increase in a linear manner for each orthodontic stage. However, it can also be appreciated that the balancing torque may gradually increase in any other suitable manners. It should be noted that the balancing torque described herein is a designed value or an expected value of tooth movement/rotation, and is not an actual value of tooth movement/rotation after the patient has been treated with the aligner.

Still referring to FIG. 1, after step 102 of anchorage preparation for the posterior teeth and the distal movement step for the cuspid tooth begin, the teeth in the group of anterior teeth also need to be treated. To be more specific, as shown in step 106, the anterior teeth can be aligned, depressed, and retracted (moved inwardly in a sagittal direction). It can be appreciated that step 106 of the orthodontic process for the anterior teeth may be slightly later than step 104 of the distal movement of the cuspid tooth, as the distal movement of the cuspid tooth may provide space for the alignment of the anterior teeth (which need to be retracted). In the embodiment shown in FIG. 1, the step 106 of the orthodontic process for the anterior teeth is slightly later than the distal movement of the cuspid tooth, but may be implemented substantially throughout the whole orthodontic method. It can be appreciated that compared with the traditional method where the distal movement of the cuspid tooth is implemented when the anchorage preparation for the posterior teeth is completed or close to completion, the distal movement of the cuspid tooth according to the present application is significantly advanced, therefore enabling the orthodontic process of the anterior tooth to be advanced as well, which further reduces the total duration of the orthodontic method. As mentioned above, in some cases, the orthodontic process of the anterior teeth may even be implemented at the same time as the anchorage preparation for the posterior teeth.

At a later phase of the orthodontic process, the retraction of the anterior teeth may be implemented simultaneously or at least partially simultaneously with step 108 of the mesial movement of the posterior teeth, for example, the retraction of the anterior teeth and the mesial movement of the posterior teeth may be implemented simultaneously during at least one stage of the orthodontic process. Preferably, during the movement of the anterior teeth, the cuspid tooth may also be moved distally at the same time, so that in some examples, as shown in FIG. 1, the alignment/retraction of the anterior teeth and the distal movement of the cuspid tooth may be implemented simultaneously with the mesial movement of the posterior teeth during at least one orthodontic stage (implemented by at least one dental appliance). In some preferred embodiments, for a set of dental appliances implementing the oral orthodontic method, the number of dental appliances that are capable of implementing the anchorage preparation for the posterior teeth, the distal movement of the cuspid tooth and alignment/depression of the anterior teeth simultaneously is at least 30%, preferably at least 50%, and more preferably at least 70% of the number of dental appliances that are capable of the anchorage preparation for the posterior teeth. In some preferred embodiments, at least one aligner may be applied simultaneously to at least two teeth or all teeth in the group of posterior teeth so that they can be moved mesially together (but not necessarily moved by the same magnitude together in the mesial direction), thereby causing the posterior teeth to be moved as a group. Similarly, at least one aligner may also be applied simultaneously to at least two teeth or all teeth in the anterior teeth group so that they can be moved in the distal direction together (but not necessarily moved by the same magnitude together in the distal direction), thereby causing these teeth to be moved as a group similarly. It can be appreciated that in some embodiments, the teeth in the group of anterior teeth may be moved as a group while the teeth in the group of posterior teeth may be moved individually. On the contrary, in some alternative embodiments, the teeth in the group of posterior teeth may be moved as a group while the teeth in the anterior teeth group may be moved individually. It can be appreciated that those who are skilled in the art may make adjustments or settings according to actual needs.

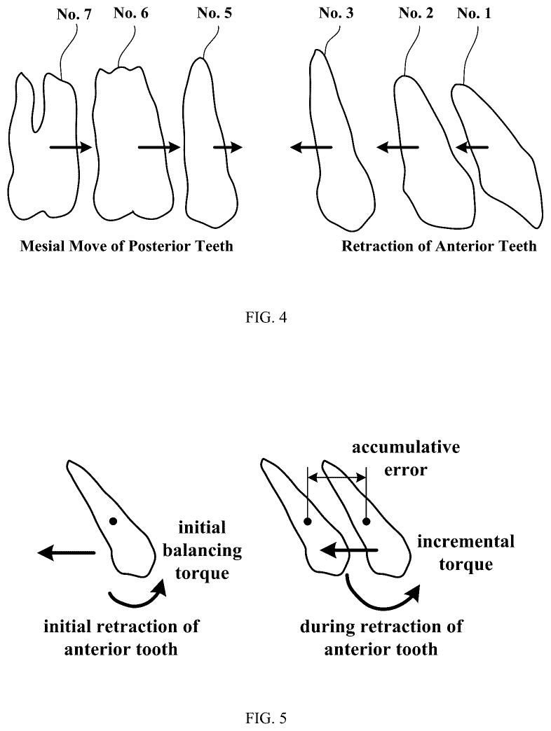

FIG. 4 illustrates an example of moving posterior teeth in a mesial direction and retracting anterior teeth. As shown in FIG. 4, tooth No. 1, tooth No. 2 and tooth No. 3 in the group of anterior teeth are retracted and are subjected to retracting forces, while at the same time tooth No. 5, tooth No. 6 and tooth No. 7 in the group of posterior teeth are moved mesially and are subjected to mesial forces. The mesial forces of the posterior teeth and the retracting forces of the anterior teeth may form interactive anchorage to each other. In this case, similar to the group of anterior teeth, the group of posterior teeth can be viewed as a whole, with the two groups of teeth moving towards each other as a whole, and each group of teeth may provide anchorage for the other group of teeth.

FIG. 5 illustrates an example of retracting anterior teeth. As shown in FIG. 5, similar to the distal movement of the cuspid tooth shown in FIG. 3, an initial balancing torque may be applied to the anterior teeth at the beginning of the retraction of the anterior teeth, and the initial balancing torque is significantly greater than the balancing torque in each stage of the retraction of the anterior teeth, where the balancing torque in each stage is achieved by evenly distributing an expected retraction magnitude of the anterior teeth among all stages of the retraction of the anterior teeth. Afterwards, on the basis of the initial balancing torque, the balancing torque may gradually increase when the orthodontic stages are implemented until the desired balancing torque is reached. The increase of the balancing torque may be referred to the above description of the increase of the balancing torque of the cuspid tooth. That is, the balancing torque may increase gradually in a linear manner, or in any other suitable manners. In some embodiments, for the maxillary dentition, a total cumulative balancing torque of the anterior teeth may not exceed 30 degrees, preferably range from 5 degrees to 20 degrees. For the mandibular dentition, a total cumulative balancing torque of the anterior teeth may not exceed 30 degrees, preferably range from 5 degrees to 20 degrees.

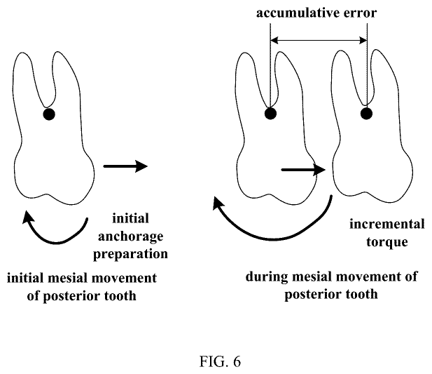

FIG. 6 illustrates an example of moving posterior teeth in a mesial direction. As shown in FIG. 6, similar to the distal movement of the cuspid tooth described in FIG. 3, an initial anchorage preparation torque may be applied to the posterior teeth at the beginning of the mesial movement of the posterior teeth. Afterwards, on the basis of the initial anchorage preparation torque, the anchorage preparation torque may gradually increase when the orthodontic stages are implemented until the desired anchorage preparation torque is reached. In some embodiments, the initial anchorage preparation torque may not exceed 40 degrees, preferably range from 5 degrees to 20 degrees.

In the embodiments shown in FIG. 3, FIG. 5 and FIG. 6, respective certain magnitudes of initial balancing torque or anchorage torque are applied to the cuspid tooth, anterior teeth and posterior teeth, to avoid inclination of the teeth at the beginning of the corresponding orthodontic stages, which may prevent unnecessarily cumulative errors during the subsequent orthodontic process. In addition, the dynamic adjustment of the torque applied by aligners after the initial torque may also be mechanically designed based on the errors generated during the orthodontic process, with covariates including the difference between the magnitude of designed tooth movement and the magnitude of actual tooth movement at a certain orthodontic stage, and the magnitude of expected tooth movement. In some embodiments, the balancing torque for a given tooth (at different stages throughout the orthodontic process) may be determined based on the total magnitude of the designed tooth movement, and/or based on the magnitude of the designed tooth movement and the magnitude of the actual tooth movement (it can be understood that the magnitude of the actual tooth movement is still a predicted value, e.g., predicted based on an achievement rate); or the balancing torque for a given tooth may be determined based on a mechanical analytical approach (referring to the scheme described in PCT patent application PCT/CN2022/100124, the entire contents of which are incorporated into the present application by reference).

The dental appliances and orthodontic method using such dental appliances have been used in some patients. It is noted that orthodontic stages for the treatment of most patients can be reduced by 20 to 30% while the same or similar therapeutic effects can be realized. Thus, the treatment time for patients can be significantly reduced.

Various embodiments have been described herein with reference to the accompanying drawings. It will, however, be evident that various modifications and changes may be made thereto, and additional embodiments may be implemented, without departing from the broader scope of the invention as set forth in the claims that follow. Further, other embodiments will be apparent to those skilled in the art from consideration of the specification and practice of one or more embodiments of the invention disclosed herein. It is intended, therefore, that this application and the examples herein be considered as exemplary only, with a true scope and spirit of the invention being indicated by the following listing of exemplary claims.

1. A dental appliance system, comprising:
a set of dental appliances for progressively closing a tooth gap between a group of posterior teeth and an intermediate tooth in a patient's dentition, wherein the intermediate tooth is adjacent to the tooth gap and between the tooth gap and a group of anterior teeth in the patient's dentition; and wherein the set of dental appliances comprise:
a first plurality of dental appliances for implementing anchorage preparation for the group of posterior teeth and performing one or both of moving the intermediate tooth distally and treating the group of anterior teeth; and
a second plurality of dental appliances for moving the group of posterior teeth mesially after the anchorage preparation for the group of posterior teeth has been implemented by the first plurality of dental appliances.

2. The dental appliance system of claim 1, wherein the first plurality of dental appliances comprise:
a first subset of dental appliances, each being configured for implementing anchorage preparation for the group of posterior teeth; and
a second subset of dental appliances, each being configured for both implementing anchorage preparation for the group of posterior teeth and moving the intermediate tooth distally;
wherein the first subset of dental appliances are configured for being used by the patient prior to the second subset of dental appliances.

3. The dental appliance system of claim 1, wherein the first plurality of dental appliances comprise:
a first subset of dental appliances, each being configured for both implementing anchorage preparation for the group of posterior teeth and moving the intermediate tooth distally; and
a second subset of dental appliances, each being configured for moving the intermediate tooth distally;
wherein the first subset of dental appliances are configured for being used by the patient prior to the second subset of dental appliances.

4. The dental appliance system of claim 1, wherein the second plurality of dental appliances are further configured for moving the intermediate tooth distally, and the second plurality of dental appliances comprise:
a first subset of dental appliances, each being configured for both moving the intermediate tooth distally and moving the group of posterior teeth mesially; and
a second subset of dental appliances, each being configured for moving the group of posterior teeth mesially;
wherein the first subset of dental appliances are configured for being used by the patient prior to the second subset of dental appliances.

5. The dental appliance system of claim 1, wherein the first plurality of dental appliances are further configured for implementing anchorage preparation for the group of posterior teeth and performing both of moving the intermediate tooth distally and treating the group of anterior teeth.

6. The dental appliance system of claim 5, wherein the first plurality of dental appliances comprise:
a first subset of dental appliances, each being configured for moving the intermediate tooth distally, implementing anchorage preparation for the group of posterior teeth and treating the group of anterior teeth; and
a second subset of dental appliances, each being configured for moving the intermediate tooth distally and treating the group of anterior teeth;
wherein the first subset of dental appliances are configured for being used by the patient prior to the second subset of dental appliances.

7. The dental appliance system of claim 5, wherein the first plurality of dental appliances comprise:
a first subset of dental appliances, each being configured for moving the intermediate tooth distally and implementing anchorage preparation for the group of posterior teeth; and
a second subset of dental appliances, each being configured for moving the intermediate tooth distally, implementing anchorage preparation for the group of posterior teeth and treating the group of anterior teeth; and
a third subset of dental appliances, each being configured for moving the intermediate tooth distally and treating the group of anterior teeth;
wherein the first, second and third subsets of dental appliances are configured for being used by the patient sequentially.

8. The dental appliance system of claim 1, wherein the group of posterior teeth comprises three or four posterior teeth, and the first plurality of dental appliances are configured to implement anchorage preparation for one of the three or four posterior teeth by using at least the remaining teeth of the three or four posterior teeth to provide anchorage for the posterior tooth.

9. The dental appliance system of claim 1, wherein the first plurality of dental appliances are configured to implement anchorage preparation for the posterior teeth separately and sequentially from the most distal tooth to the most mesial tooth.

10. The dental appliance system of claim 1, wherein the first plurality of dental appliances are configured to implement anchorage preparation for one of the posterior teeth by inclining the posterior teeth distally to generate an anchorage moment for the posterior teeth.

11. The dental appliance system of claim 1, wherein one or more of the first plurality of dental appliances for moving the intermediate teeth distally are further configured to apply an initial balancing torque to the intermediate tooth to counter a toque that causes the intermediate tooth to move distally, such that the intermediate tooth can be translated and provide anchorage for the group of posterior teeth during its distal movement.

12. The dental appliance system of claim 11, wherein the initial balancing torque applied to the intermediate tooth depends on a size of the tooth gap to be closed.

13. The dental appliance system of claim 11, wherein one or more of the first plurality of dental appliances for moving the intermediate tooth distally are further configured to apply a balancing torque that increases incrementally from the initial balancing torque to an expected balancing torque.

14. The dental appliance system of claim 13, wherein the balancing torque increases incrementally from the initial balancing torque to the expected balancing torque in a linear manner for each of the dental appliance.

15. The dental appliance system of claim 1, wherein the first plurality of dental appliances comprise:
a first subset of dental appliances each being configured for both implementing anchorage preparation and treating the group of anterior teeth;
a second subset of dental appliances each being configured for implementing anchorage preparation, moving the intermediate tooth, and treating the group of anterior teeth;
wherein the first subset of dental appliances are configured for being used by the patient prior to the second subset of dental appliances.

16. The dental appliance system of claim 1, wherein treating the group of anterior teeth comprises aligning, depression or retracting the group of anterior teeth.

17. The dental appliance system of claim 16, wherein treating the group of anterior teeth comprises moving two or more of the group of anterior teeth together.

18. The dental appliance system of claim 1, wherein mesially moving posterior teeth comprises moving two or more of the group of posterior teeth together.

19. A method for producing a plurality of digital data sets representing a series of discrete tooth arrangements progressing from an initial arrangement to a final arrangement, said method comprising:
providing a digital data set representing an initial tooth arrangement;
providing a digital data set representing a final tooth arrangement;
producing a plurality of successive digital data sets based on the provided digital data sets, wherein said plurality of digital data sets represent a series of successive tooth arrangements progressing from the initial tooth arrangement to the final tooth arrangement and each corresponding a stage of a series of orthodontic stages for progressively closing a tooth gap between a group of posterior teeth and an intermediate tooth in a patient's dentition; wherein the series of orthodontic stages comprises:
a first plurality of orthodontic stages for implementing anchorage preparation for the group of posterior teeth and performing one or both of moving the intermediate tooth distally and treating the group of anterior teeth; and
a second plurality of orthodontic stages for mesially moving the group of posterior teeth after the anchorage preparation for the group of posterior teeth has been implemented by the first plurality of orthodontic stages.
